(19) United States
(12) Patent Application Publication
(10) Pub. No.: US 2012/0198979 A1
(43) Pub. Date: Aug. 9, 2012

(54) ROTARY DIE CUTTER

(76) Inventor: Shin Ohsawa, Ibaraki (JP)

(21) Appl. No.: 13/361,793

(22) Filed: Jan. 30, 2012

(30) Foreign Application Priority Data
Feb. 4, 2011 (JP) 022691/2011

(51) Int. Cl. B26D 7/18

(52) U.S. Cl. 83/98

(57) ABSTRACT

A rotary die cutter including a die plate including a blade which die cuts a material, die cylinder, opposed cylinder, air blowing device, receiving device, and guide device. The die cylinder mounts the die plate on its circumferential surface and is supported rotatably. The opposed cylinder is opposed to the die cylinder and supported rotatably. The die cylinder cuts the material using the die plate at the position at which the die cylinder is opposed to the opposed cylinder. The air blowing device blows air onto the circumferential surface of the die cylinder in the tangential direction to the die cylinder from the downstream side to the upstream side in the direction in which the die cylinder rotates. The receiving device receives the cut piece peeled from the die plate by the air blown from the air blowing device. The guide device guides the cut piece to the receiving device.

### BACKGROUND OF THE INVENTION

The present invention relates to a rotary g die cutter including a flexible die which is fixed on a die cylinder and has blade dies that cut a material to be die-cut, such as a sheet or a web, and, more particularly, to a flexible die type rotary die cutter including a flexible die fixed onto a magnet cylinder by magnetic attraction.

Recently, a rotary die cutter for die-cutting only a necessary portion in a material to be die-cut, such as paper, corrugated cardboard, high polymer film, or rubber sheet has been presented. To die-cut a necessary portion, a rotary die cutter of this type die-cuts the necessary portion along its contour while leaving part of a material to be die-cut intact as joints. In such rotary die-cutting, it is often the case that the joints are torn from the material to be die-cut upon die-cutting, and cut pieces adhere onto the blade surfaces of cutting blades. In such a case, if the next material to be die-cut is supplied to the gap between a die cylinder and an anvil cylinder without removing these cut pieces, the two objects: the material to be die-cut and the cut pieces are stacked on each other in the gap between the die cylinder and the anvil cylinder, thus posing problems such as depression or bending of the cylinder or damage to a bearing.

As a countermeasure against these problems, solid die type rotary die cutter including blade dies formed integrally with a die cylinder, and a segment type rotary die-cutter including thick metallic blade dies (10 to 20 mm) which is fixed to the periphery of a die cylinder via a bolt and die-cuts pieces in a predetermined die pattern are conventionally provided with an air reject device which peels cut pieces adhering on the blade surfaces of cutting blades by the action of compressed air blowing from an air blowing hole into the die cylinder. Alternatively, these types of rotary die cutter are provided with a spring reject device which physically peels the adhering cut pieces from the die cylinder using a pin or leaf spring having an elastic spring force biased outwards by a spring.

Unfortunately, because a flexible die type rotary die cutter which fixes, by magnetic attraction, a thin flexible die including blade dies formed integrally with a magnet cylinder die-cuts cut pieces having various shapes, an air blowing hole cannot be provided at a predetermined position on the magnet cylinder in this machine. Also, as shown in FIG. 9, when a length L from the surface of a thin flexible die 101 to its blade edge is 0.3 to 0.7 mm, and a thickness t of general paper 102 is 0.1 to 0.4 mm, an interval 1 between the die surface and the surface of the material to be die cut in die-cutting is as small as 0.2 to 0.6 mmm, so a pin or a leaf spring cannot be fixed in position.

### SUMMARY OF THE INVENTION

It is an object of the present invention to provide a rotary die cutter capable of preventing depression or bending of a cylinder or damage to a bearing due to factors associated with cut pieces adhering on a flexible die.

In order to achieve the above-mentioned objects, according to the present invention, there is provided a rotary die cutter comprising, a die plate including a blade die which die-cuts a material to be die-cut, a die cylinder which mounts the die plate on a circumferential surface thereof and is supported rotatably, an opposed cylinder which is opposed to the die cylinder and supported rotatably, the die cylinder cutting the material to be die-cut, that is held by the opposed cylinder, using the die plate at an opposition position at which the die cylinder is opposed to the opposed cylinder, an air blowing device which blows air onto the circumferential surface of the die cylinder in a tangential direction to the die cylinder from a downstream side to an upstream side in a direction in which the die cylinder rotates, so as to peel a cut piece that is torn from the material to be die-cut upon die-cutting and adheres onto the die plate, a receiving device which receives the cut piece peeled from the die plate by the air blown from the air blowing device, and a guide device which guides the cut piece peeled from the die plate to the receiving device.

In the present invention, the rotary die cutter includes an air blowing device, guide device, and receiving device. The air blowing device blows air in nearly the tangential direction to the die cylinder in the period from when the die cylinder is opposed to the opposed cylinder first until they are opposed to each other next. The guide device guides cut pieces having their leading edges peeled by the air. The receiving device receives the cut pieces guided by the guide device. According to the present invention, even a flexible die type die cutter can reliably peel cut pieces adhering on a die plate to prevent depression or bending of a cylinder or damage to a bearing.

### BRIEF DESCRIPTION OF HE DRAWINGS

FIG. 1 is a side view showing a sheet-fed offset rotary printing press to which a rotary die cutter according to the present invention is applied;

FIG. 2 is a side view showing a rotary die cutter according to an embodiment of the present invention;

FIG. 3A is a plan view showing a die cylinder shown in FIG. 2;

FIG. 3B is an enlarged view showing a portion III(B) in FIG. 3A;

FIG. 4A is a perspective view showing a flexible die magnetically fixed onto the die cylinder shown in FIG. 3A;

FIG. 4B is a sectional view taken along a line IV-IV in FIG. 4A;

FIG. 5A is a perspective view showing the die cylinder shown in FIG. 2;

FIG. 5B is a perspective view showing the state in which a flexible die shown in FIG. 5A is fixed on the die cylinder;

FIG. 6 is a side view which shows a rotary die cutter and explains its die-cutting operation;

FIG. 7 is an enlarged side view showing the main part of FIG. 6;

FIG. 8 is a side view showing the schematic arrangement of another printing press to which the rotary die cutter according to the present invention is applied; and

FIG. 9 is a model view for explaining the interval between the die surface and the surface of a material to be die-cut in a flexible die type die cutter.

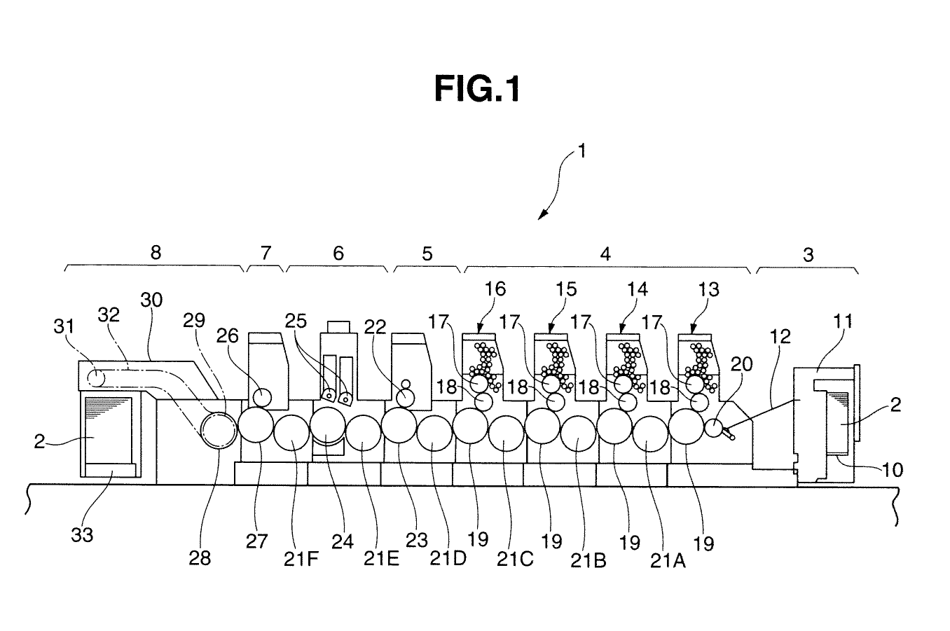

### DESCRIPTION OF THE PREFERRED EMBODIMENT

An embodiment according to the present invention will be described in detail below with reference to the accompanying drawings.

A sheet-fed offset rotary printing press 1 according to this embodiment includes a sheet feed device 3, printing device 4, coating unit 5, drying unit 6, flexible die type rotary die cutter 7, and sheet delivery device 8. The sheet feed device supplies sheets 2 serving as materials to be die-cut one by one. The printing device 4 prints on the sheets 2 supplied from the sheet feed device 3. The coating unit 5 coats varnish on the sheets 2 printed by the printing device 4. The drying unit 6 dries the sheets 2 coated with varnish by the coating unit 5. The rotary die cutter 7 performs hand push cutting of the sheets 2 dried by the drying unit 6 into a predetermined pattern. The sheet delivery device 8 delivers the cut sheets 2 having cut pieces.

The sheet feed device 3 includes a pile board (sheet stacking device) 10 and sheet feed unit (sheet supply unit) 11. The pile board 10 stacks the sheets 2 in a pile. The sheet feed unit 11 separates the sheets 2 stacked on the pile board 10 one by one, and feeds them to a feeder board 12.

The printing device 4 includes four printing units 13 to 16. Each of the printing units 13 to 16 includes a plate cylinder 17, blanket cylinder 18, and impression cylinder 19. The plate cylinder 17 is supplied with ink from an inking device. The blanket cylinder 18 is opposed to the plate cylinder 17. The impression cylinder 19 is opposed to the blanket cylinder 18 and grips and transports the sheet 2. In such a configuration, the sheet 2 supplied from the feeder board 12 onto a transfer cylinder 20 is transferred to and transported by the impression cylinder 19, and is printed in a first color upon passing through the gap between the impression cylinder 19 and the blanket cylinder 18. The sheet 2 printed in the first color is sequentially transported to the printing units 14, 15, and 16 via transfer cylinders 21A to 21C, respectively, and is printed in second, third, and fourth colors by the printing units 14, 15, and 16, respectively.

The coating unit 5 includes a varnishing cylinder 22 and impression cylinder 23. The varnishing cylinder 22 is supplied with varnish from a varnish supply unit (not shown). The impression cylinder 23 is opposed to the varnishing cylinder 22 and transports the sheet 2. The sheet 2 which is printed by the printing device 4 and transferred from a transfer cylinder 21D to the impression cylinder 23 has its surface coated with varnish upon passing through the gap between the impression cylinder 23 and the varnishing cylinder 22.

The drying unit 6 includes a UV lamp 25 and transfer cylinder 24. The UV lamp 25 dries the ink printed by the printing device 4, and the varnish coated by the coating unit 5. The transfer cylinder 24 transfers the sheet 2 from a transfer cylinder 21E, and transports it.

The rotary die cutter 7 includes a die cylinder (magnet cylinder) 26 and anvil cylinder (opposed cylinder) 27. The die cylinder 26 includes a flexible die (die plate) 49 (to be described later) mounted on its circumferential surface. The anvil cylinder 27 is opposed to the die cylinder 26 and transports the sheet 2.

The sheet delivery device 8 includes sprockets 29 and 31 and a pair of delivery chains (transporting/holding device) 32. The sprocket 29 is supported rotatably and coaxially with a delivery cylinder 28 opposed to the anvil cylinder 27 of the rotary die cutter 7. The sprocket 31 is rotatably supported at the rear end of a delivery frame 30. The pair of delivery chains 32 are looped around the sprockets 29 and 31. Delivery grippers (not shown) are mounted on the pair of delivery chains 32 with predetermined spacings between them. In such a configuration, the sheet 2 transferred from the anvil cylinder 27 to the delivery grippers of the delivery chains 32 is transported as the delivery chains 32 travel, is released from the delivery grippers at a position above a delivery pile (discharge device) 33, and is stacked on the delivery pile 33.

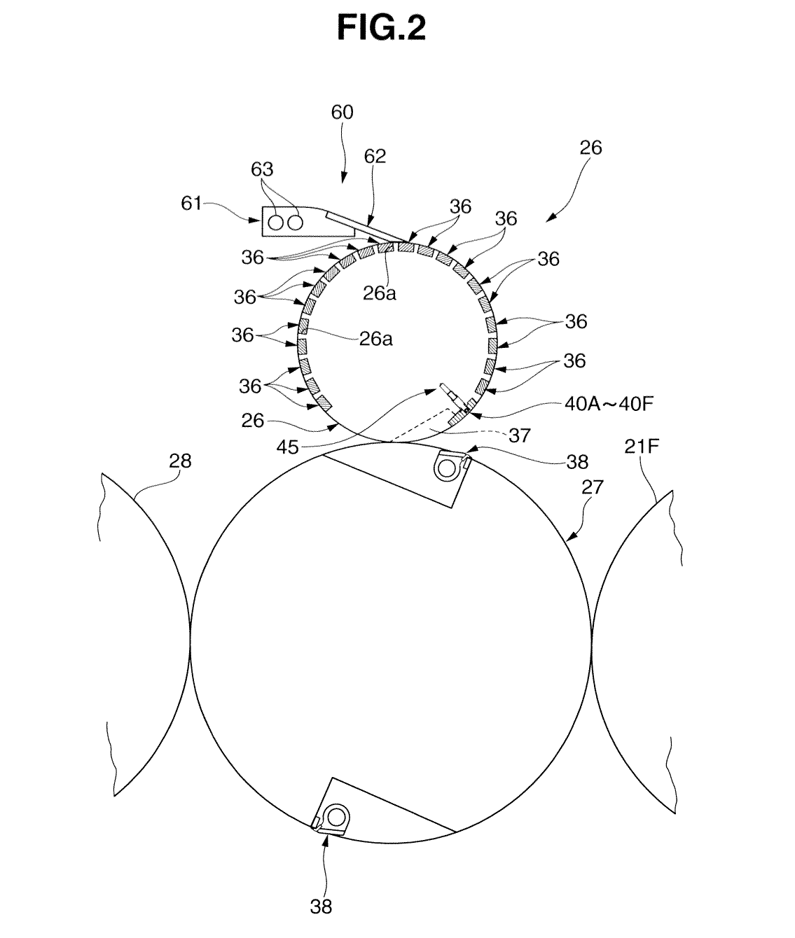

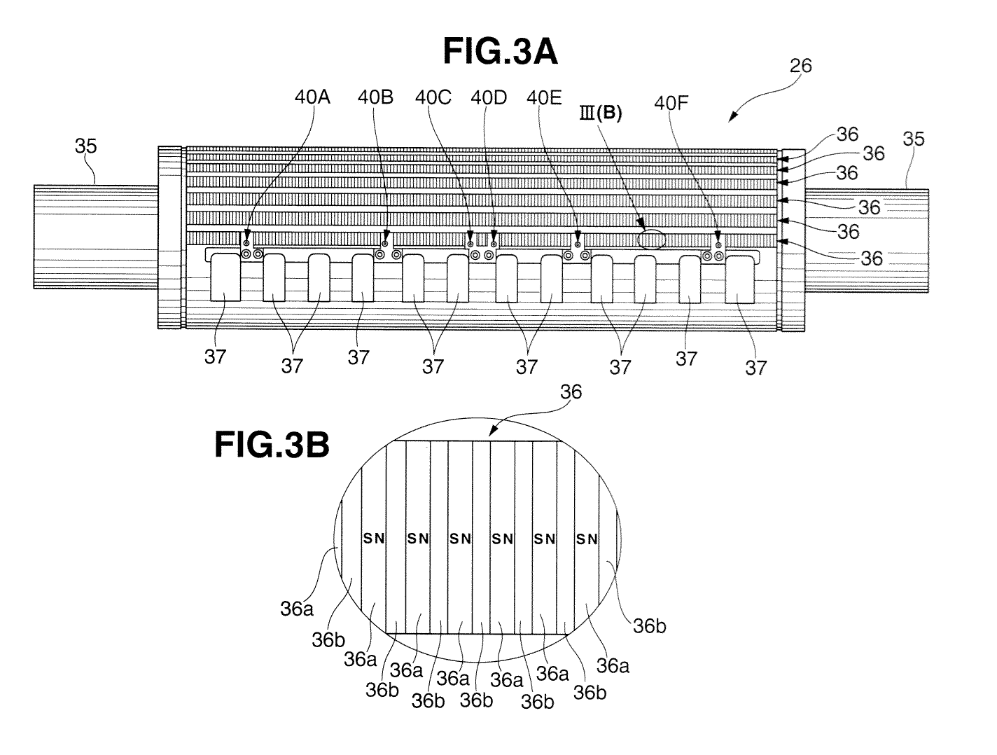

The die cylinder 26 of the rotary die cutter 7 will be described next with reference to FIGS. 2, 3A, and 3B. As shown in FIG. 3A, the die cylinder 26 has a pair of end shafts 35 projecting at its two ends, and the pair of end shafts 35 are rotatably supported by a pair of frames (not shown). A plurality of parallel grooves 26a are formed in the outer circumferential surface of the die cylinder 26 to extend in the axial direction, as shown in FIG. 2, and a band-shaped magnetic bar 36 is fitted in each groove 26a and fixed by an adhesive.

Each magnetic bar 36 is formed by large numbers of magnets 36a and yokes 36b, as shown in FIG. 3B. The magnets 36a and yokes 36b are integrated with each other while they are alternately juxtaposed to each other in the axial direction of the die cylinder 26.

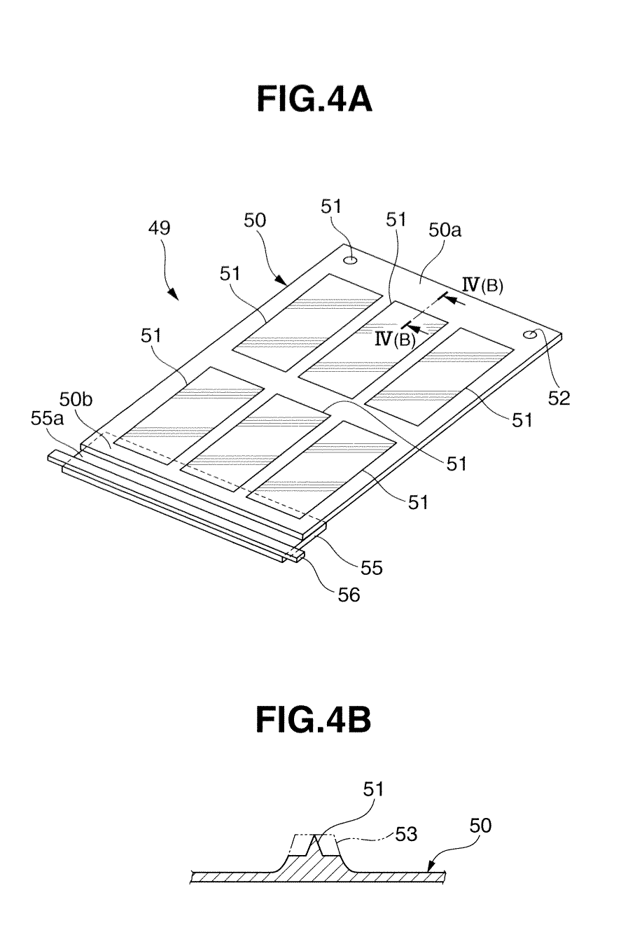

The magnets 36a are arrayed so that their magnetic poles having the same polarities (their north poles and south poles) face each other, and the yokes 36b are magnetized as they are interposed between the magnets 36a. The thus magnetized yokes 36b magnetically mount the flexible die 49 (FIG. 4A) made of a magnetic metal on the outer circumferential surface of the die cylinder 26.

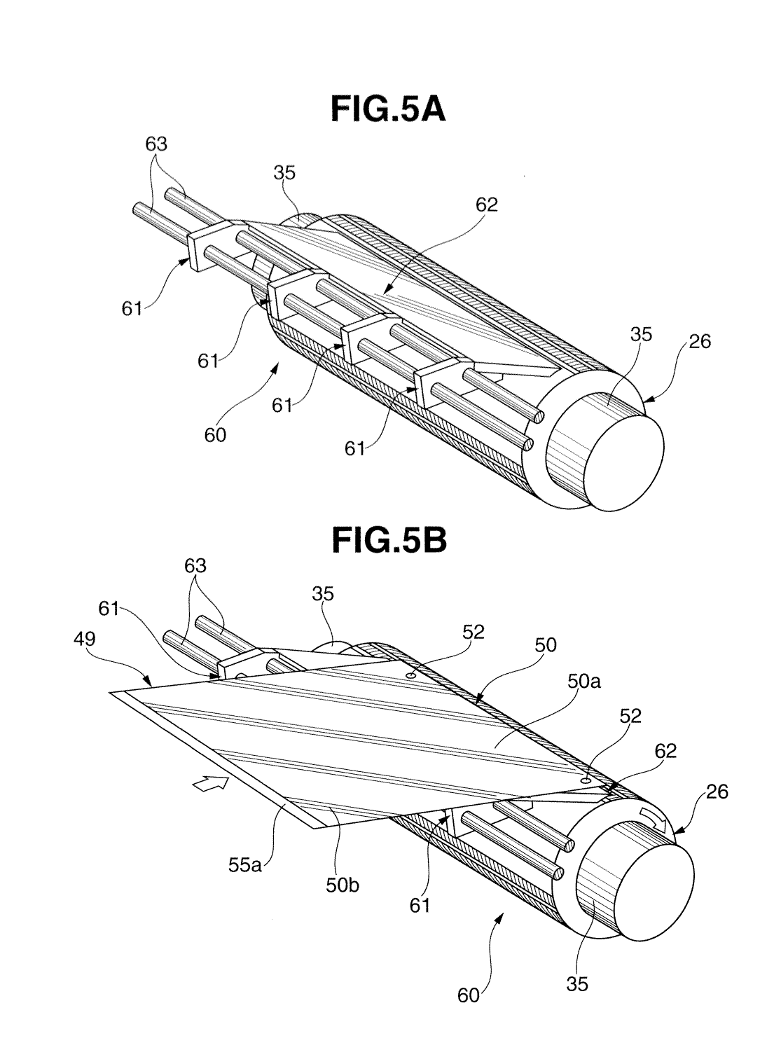

The magnetic bars 36 are provided between six reference pins 40 aligned with each other in the axial direction of the die cylinder 26 so as to clamp the reference pins 40, as shown in FIG. 3A. A plurality of rectangular recesses 37 are formed in the outer circumferential surface of the die cylinder 26 in the axial direction of the die cylinder 26. The plurality of recesses 37 are aligned with each other in the axial direction of the die cylinder 26 in correspondence with grippers 38 aligned with each other in the axial direction of the anvil cylinder 27 with spacings between them. Six reference pins 40A to 40F to be engaged in engagement holes 52 (FIG. 5B) in the flexible die 49 project from the outer circumferential surface of the die cylinder 26 so as to align themselves in the axial direction.

The flexible die 49 magnetically mounted on the outer circumferential surface of the die cylinder 26 will be described next. The flexible die 49 includes a main body plate 50, nonmagnetic sheet (nonmagnetic body portion) 55, and magnetic piece 56, as shown in FIG. 4A. The main body plate 50 is formed by a thin magnetic metal plate which has flexibility and is magnetically mounted on the outer circumferential surface of the die cylinder 26. The nonmagnetic sheet 55 is formed integrally with one longitudinal edge (trailing edge) 50b of the main body plate 50. The magnetic piece 56 is mounted on the nonmagnetic sheet 55 and brings the nonmagnetic sheet 55 into tight contact with the outer circumferential surface of the die cylinder 26. The nonmagnetic sheet 55 is magnetically held by the magnetic piece 56 while it is kept in tight contact with the outer circumferential surface of the die cylinder 26.

The main body plate 50 having flexibility is formed in a rectangle by a magnetic metal, and includes, on its front surface, six rectangular ring-shaped (box shaped) cutting blades (blade dies) 51. The cutting blades 51 cut the sheet 2 into six rectangular sheet pieces while leaving joint portions (support portions) intact. For example, several joint portions are formed on one side of each rectangular sheet piece having a width of 0.2 mm. A pair of engagement holes (reference engagement portions) 52 in which the reference pins 40 are to be engaged are formed at the two ends of a leading edge 50a of the main body plate 50.

To fabricate the cutting blades 51, first, the main body plate 50 is etched, except for portions corresponding to the cutting blades 51, so that the cutting blades 51 have a predetermined height, thereby forming trapezoidal projections 53 indicated by an alternate long and two short dashed line in FIG. 4B. Then, unnecessary portions of the projections 53 are cut by an NC (Numerical Control) cutting machine to form the cutting blades 51 having isosceles triangular cross-sections.

The nonmagnetic sheet 55 is made of rectangular thin plate-shaped plastic with flexibility, and has the same width as that of the main body plate 50. The nonmagnetic sheet 55 is partially bonded to the back surface of the trailing edge 50b of the main body plate 50 over the entire width, so that almost a half of the nonmagnetic sheet 55 forms a protrusion 55a which protrudes from the trailing edge 50b of the main body plate 50. The magnetic piece 56 is formed in an elongated bar shape by a ferromagnetic material, and its dimension in the widthwise direction of the nonmagnetic sheet 55 is set larger than the width of the nonmagnetic sheet 55.

In such a configuration, to magnetically mount the flexible die 49 on the outer circumferential surface of the die cylinder 26, the magnetic piece 56 is put on the protrusion 55a of the nonmagnetic sheet 55, and magnetically mounted on the outer circumferential surface of the die cylinder 26. Thus, the protrusion 55a of the nonmagnetic sheet 55 is clamped by the magnetic piece 56 and the outer circumferential surface of the die cylinder 26, so the nonmagnetic sheet 55 curves along and comes into tight contact with the outer circumferential surface of the die cylinder 26.

A guide device 60 includes four guide pieces 61 and a guide plate 62, as shown in FIGS. 5A and 5B. The guide pieces 61 are aligned with each other in the axial direction of the die cylinder 26. The guide plate 62 has its one edge attached to the four guide pieces 61, and its other edge adjacent to the outer circumferential surface of the die cylinder 26, and extends in the axial direction of the die cylinder 26. The four guide pieces 61 are supported by two bars 63 laid horizontally across a pair of frames (not shown).

In such a configuration, the two reference pins 40A and 40F project from the outer circumferential surface of the die cylinder 26. The flexible die 49 is gripped and placed on the guide pieces 61 and guide plate 62 so that the leading edge 50a is directed toward the die cylinder 26, as shown in FIG. 5B. In this state, the pair of engagement holes 52 in the flexible die 49 are engaged in the reference pins 40A and 40F. After the pair of engagement holes 52 are engaged in the reference pins 40A and 40F, the die cylinder 26 rotates in the direction in which it is mounted, that is, clockwise in FIG. 5B.

With this rotation, the flexible die 49 is mounted on the outer circumferential surface of the die cylinder 26 sequentially from a leading edge 52a while being guided by the guide pieces 61 and guide plate 62. At this time, the flexible die 49 is magnetically mounted on the outer circumferential surface of the die cylinder 26 by the magnetic bar 36 in tight contact with each other. After the trailing edge 50b of the flexible die 49 is magnetically mounted on the outer circumferential surface of the die cylinder 26, the magnetic piece 56 is placed on the protrusion 55a of the nonmagnetic sheet 55, as shown in FIG. 4A, thereby magnetically mounting the magnetic piece 56 on the outer circumferential surface of the die cylinder 26.

Upon mounting of the magnetic piece 56, the protrusion 55a is clamped by the magnetic piece 56 and the outer circumferential surface of the die cylinder 26. Thus, the protrusion 55a curves along and comes into tight contact with the outer circumferential surface of the die cylinder 26. After mounting of the flexible die 49 on the die cylinder 26 is completed, the reference pins 40A and 40F are inserted from the outer circumferential surface of the die cylinder 26 into a recess 45.

In this state, when the sheet-fed offset rotary printing press 1 is driven, the sheet 2 transferred from a transfer cylinder 21F (FIG. 2) to the anvil cylinder 27 is cut along the contour of a predetermined shape by the cutting blades 51 of the flexible die 49 upon passing through the opposition point at which the die cylinder 26 and the anvil cylinder 27 are opposed to each other.

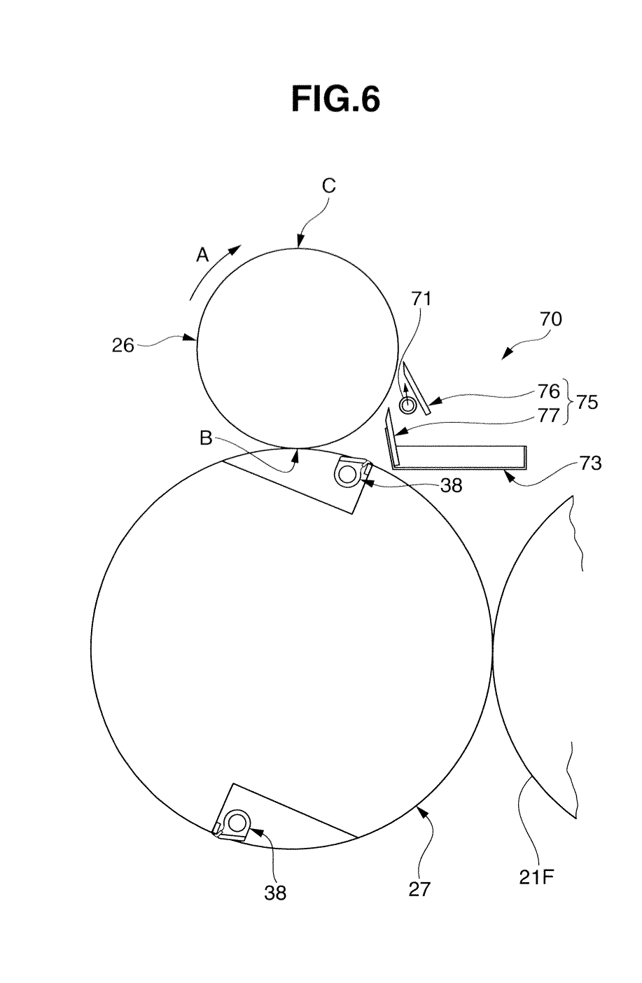

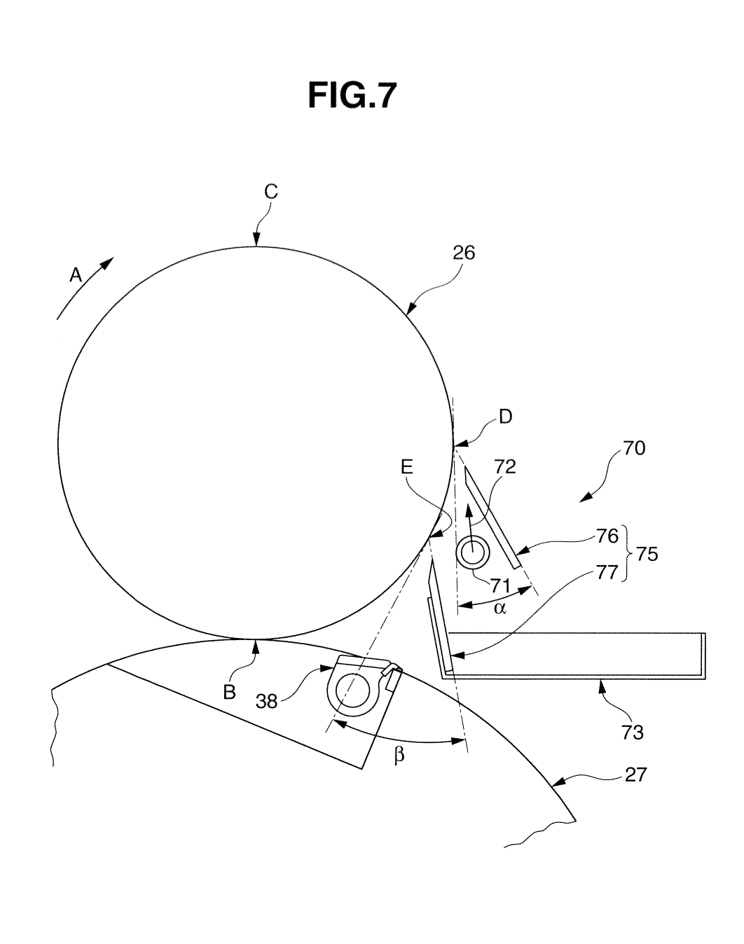

A sheet piece peeling device 70 which peels sheet pieces adhering on the die cylinder 26 will be described next with reference to FIGS. 6 and 7. Note that the guide pieces 61 and guide plate 62 are not shown in FIGS. 6 and 7, for the sake of descriptive convenience.

The peeling device 70 includes an air nozzle (air blowing device) 71, receiving tray (receiving device) 73, and guide device 75. The air nozzle 71 blows air 72 over the entire length of the die cylinder 26. The receiving tray 73 receives sheet pieces peeled from the flexible die 49 by the air 72 blown from the air nozzle 71. The guide device 75 guides the sheet pieces peeled from the flexible die 49 to the receiving tray 73. The air nozzle 71, receiving tray 73, and guide device 75 are provided in the interval from an opposition point B at which the die cylinder 26 and the anvil cylinder 27 are opposed to each other to a point C corresponding to the half-rotation position of the die cylinder 26 on the upstream side of the opposition point B in the direction in which the die cylinder 26 rotates (a direction indicated by an arrow A).

The air nozzle 71 is provided at a position other than the opposition point B at which the die cylinder 26 and the anvil cylinder 27 are opposed to each other. The air nozzle 71 has an entire length nearly equal to the axial length of the die cylinder 26, and its two ends are supported by a pair of frames (not shown). The air 72 blown from the air nozzle 71 onto the circumferential surface of the die cylinder 26 moves in nearly the tangential direction to the die cylinder 26 from the downstream side to the upstream side in the direction in which the die cylinder 26 rotates.

The receiving tray 73 has an entire length nearly equal to the diameter of the die cylinder 26, and its two ends are supported by a pair of frames (not shown).

The guide device 75 includes a first blade (first guide device) 76 and second blade (second guide device) 77. The first blade 76 has a plate shape and is provided upstream of the air nozzle 71 in the direction in which the die cylinder 26 rotates (a direction indicated by the arrow A). The second blade 77 has a plate shape and is provided downstream of the air nozzle 71 in the direction in which the die cylinder 26 rotates (a direction indicated by the arrow A). The two blades 76 and 77 have an entire length nearly equal to the diameter of the die cylinder 26, and their distal ends are slightly spaced apart from the circumferential surface of the die cylinder 26. The blade 76 has their two ends supported by a pair of frames (not shown), and the blade 77 has its proximal end fixed on the receiving tray 73.

The blades 76 and 77 are arranged so that their distal ends are adjacent to the circumferential surface of the die cylinder 26. An angle α formed between the blade 76 and a tangent to the circumferential surface of the die cylinder 26 at an intersection point D between the circumferential surface of the die cylinder 26 and an extension of the blade 76 on the distal end side is set to 45 or less. Also, an angle β formed between the blade 77 and a tangent to the circumferential surface of the die cylinder 26 at an intersection point E between the circumferential surface of the die cylinder 26 and an extension of the blade 77 of the distal end side is set to 45° or less.

In such a configuration, the sheet 2 transferred from the transfer cylinder 21E to the grippers 38 of the anvil cylinder 27 is transported to the opposition point B at which the die cylinder 26 and the anvil cylinder 27 are opposed to each other. At the opposition point B, the sheet 2 is cut by the cutting blades 51 of the flexible die 49 mounted on the outer circumferential surface of the die cylinder 26.

At this time, if sheet pieces peeled from the sheet 2 adhere onto the cutting blades 51, they are transported while they are kept adhering on the die cylinder 26, and pass through the point C corresponding to the position to which the die cylinder 26 rotates through 180° from the opposition point B. Because the air 72 is blown from the air nozzle 71 onto the sheet pieces adhering on the die cylinder 26, it peels the sheet pieces from the die cylinder 26. The sheet pieces peeled from the die cylinder 26 are guided by the blades 76 and 77 and received by the receiving tray 73.

Further, the use of the air 72 may be insufficient to completely peel the sheet pieces from the die cylinder 26. In such a case, the blades 76 and 77 abut against the sheet pieces, having their leading edges in the rotation direction peeled partially, at an acute angle of 45° or less to physically completely peel these sheet pieces. In this manner, the air 72 from the air nozzle 71 and the blades 76 and 77 cooperate with each other to completely peel the partially peeled sheet pieces from the die cylinder 26, and reliably guide them to the receiving tray 73.

As described above, in this embodiment, the peeling device 70 includes the air nozzle 71, blades 76 and 77, and receiving tray 73. The air nozzle 71 partially peels sheet pieces adhering on the die cylinder 26 by air in the period from when the die cylinder 26 is opposed to the anvil cylinder 27 first until they are opposed to each other next (during rotation through 360°). The blades 76 and 77 guide the partially peeled sheet pieces. The receiving tray 73 receives the sheet pieces guided by the blades 76 and 77. According to this embodiment, even a flexible die type die cutter can reliably peel sheet pieces adhering on the die cylinder 26 to prevent depression or bending of a cylinder or damage to a bearing.

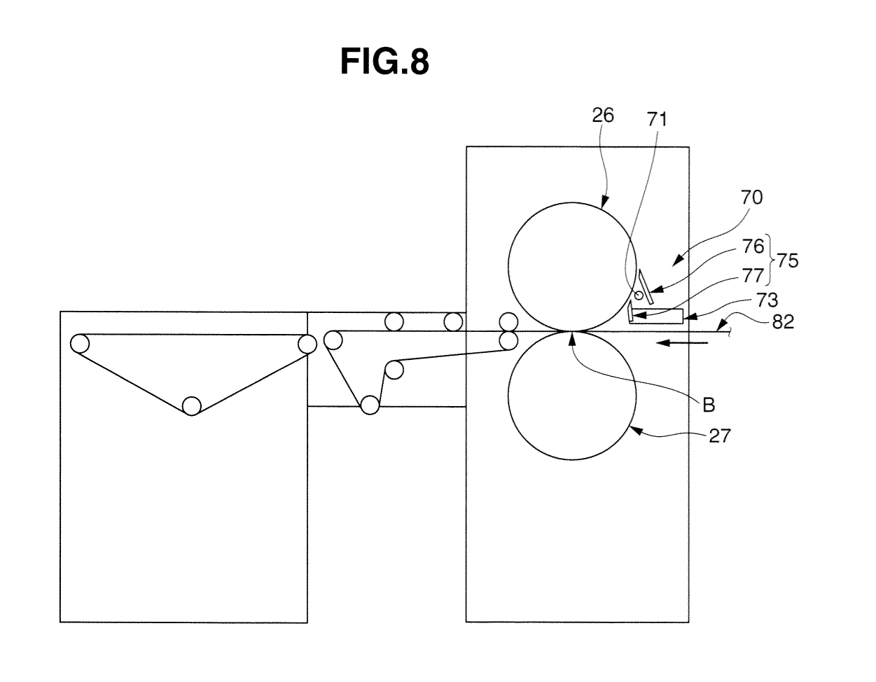

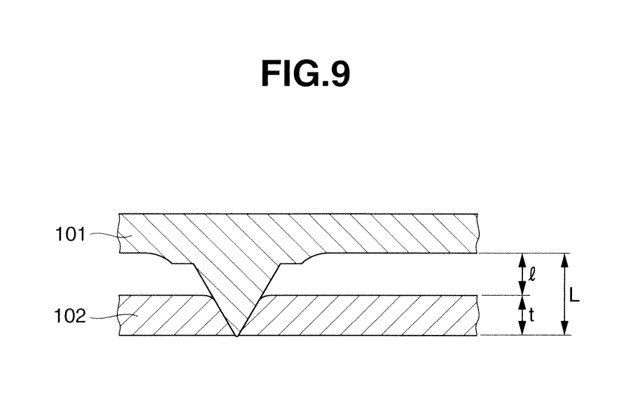

FIG. 8 illustrates an example in which the material to be die-cut is a web 82 in place of the sheet 2. In this example as well, if part of the web 82 adheres onto the flexible die 49 of the die cylinder 26 at the opposition point B, sheet pieces adhering on the flexible die 49 are peeled by the sheet piece peeling device 70 and received by the receiving tray 73, as in the above-mentioned case of the sheet 2.

Note that an example in which a magnet cylinder is used as the die cylinder 26 has been described in this embodiment. However, the structure which fixes the flexible die onto the die cylinder is not limited to this, and various design changes can be made. As disclosed in, for example, U.S. Pat. No. 7,565,856, a flexible die type die cutter of a type which includes a shoulder having a bolt hole formed in it at a position shifted from the pivot center may be used. In this case, a bolt inserted in a through hole formed at the longitudinal edge of the flexible die is screwed into the bolt hole, and the shoulder is pivoted, thereby pulling and mechanically holding the flexible die on the die cylinder.

What is claimed is:

1. A rotary die cutter comprising:
a die plate including a blade die which die-cuts a material to be die-cut;
a die cylinder which mounts said die plate on a circumferential surface thereof and is supported rotatably;
an opposed cylinder which is opposed to said die cylinder and supported rotatably, said die cylinder die-cutting the material to be die-cut, that is held by said opposed cylinder, using said die plate at an opposition position at which said die cylinder is opposed to said opposed cylinder;
an air blowing device which blows air onto the circumferential surface of said die cylinder in a tangential direction to said die cylinder from a downstream side to an upstream side in a direction in which said die cylinder rotates, so as to peel a cut piece that is torn from the material to be die-cut upon die-cutting and adheres onto said die plate;
a receiving device which receives the cut piece peeled from said die plate by the air blown from said air blowing device; and
a guide device which guides the cut piece peeled from said die plate to said receiving device.

2. A machine according to claim 1, wherein
said die plate is formed by a magnetic metal plate, and
said die cylinder is a magnet cylinder which holds said die plate on the circumferential surface thereof by magnetic attraction.

3. A machine according to claim 1, wherein said air blowing device, said guide device, and said receiving device are provided upstream of an opposition point, at which said die cylinder and said opposed cylinder are opposed to each other, in the direction in which said die cylinder rotates.

4. A machine according to claim 3, wherein said air blowing device, said guide device, and said receiving device are provided in an interval from the opposition point at which said die cylinder and said opposed cylinder are opposed to each other to a half-rotation position of said die cylinder on the upstream side of the opposition point in the direction in which said die cylinder rotates.

5. A machine according to claim 1, wherein
said guide device comprises
a first blade which is provided upstream of said air blowing device in the direction in which said die cylinder rotates, and has a distal end thereof adjacent to the circumferential surface of said die cylinder, and
a second blade which is provided downstream of said air blowing device in the direction in which said die cylinder rotates, and has a distal end thereof adjacent to the circumferential surface of said die cylinder.

6. A machine according to claim 5, wherein
an angle formed between said first blade and a tangent to the circumferential surface of said die cylinder at an intersection point between the circumferential surface of said die cylinder and an extension of said first blade on a distal end side is set to an angle of not more than 45°, and
an angle formed between said second blade and a tangent to the circumferential surface of said die cylinder at an intersection point between the circumferential surface of said die cylinder and an extension of said second blade on a distal end side is set to an angle of not more than 45°.
